(19) United States
(12) Patent Application Publication
(10) Pub. No.: US 2025/0267716 A1
(43) Pub. Date: Aug. 21, 2025

(54) UPLINK CONTROL SIGNALING FOR POWER ADAPTATION

(71) Applicant: Samsung Electronics Co., Ltd., Suwon-si (KR)

(72) Inventors: Carmela Cozzo, San Diego, CA (US); Aristides Papasakellariou, Houston, TX (US); Hongbo Si, Allen, TX (US)

(21) Appl. No.: 19/047,540

(22) Filed: Feb. 6, 2025

Related U.S. Application Data
(60) Provisional application No. 63/555,814, filed on Feb. 20, 2024.
(60) Provisional application No. 63/642,589, filed on May 3, 2024.
(60) Provisional application No. 63/656,434, filed on Jun. 5, 2024.
(60) Provisional application No. 63/673,551, filed on Jul. 19, 2024.

(51) Int. Cl. H04W 74/0833; H04B 7/06; H04L 27/26

(52) U.S. Cl. CPC H04W 74/0833; H04B 7/06968; H04L 27/2656

(57) ABSTRACT

Apparatuses and methods for uplink control signaling for power adaptation. A method performed by a user equipment (UE) in a wireless communication system includes receiving, on a first cell, a synchronization signal associated with first quasi-collocation properties on the first cell, transmitting, on the first cell, a physical random access channel (PRACH) in response to the reception of the synchronization signal, and receiving, on the first cell, a synchronization signal and physical broadcast channel (SS/PBCH) block associated with second quasi-collocation properties in response to the transmission of the PRACH.

### CROSS-REFERENCE TO RELATED AND CLAIM OF PRIORITY

The present application claims priority under 35 U.S.C. § 119 (e) to U.S. Provisional Patent Application No. 63/555,814 filed on Feb. 20, 2024; U.S. Provisional Patent Application No. 63/642,589 filed on May 3, 2024; U.S. Provisional Patent Application No. 63/656,434 filed on Jun. 5, 2024; and U.S. Provisional Patent Application No. 63/673,551 filed on Jul. 19, 2024, which are hereby incorporated by reference in their entirety.

### TECHNICAL FIELD

The present disclosure relates generally to wireless communication systems and, more specifically, the present disclosure is related to apparatuses and methods for uplink control signaling for power adaptation.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to uplink control signaling for power adaptation.

In one embodiment, a method performed by a user equipment (UE) in a wireless communication system is provided. The method includes receiving, on a first cell, a synchronization signal associated with first quasi-collocation properties on the first cell, transmitting, on the first cell, a physical random access channel (PRACH) in response to the reception of the synchronization signal, and receiving, on the first cell, a synchronization signal and physical broadcast channel (SS/PBCH) block associated with second quasi-collocation properties in response to the transmission of the PRACH.

In another embodiment, a UE is provided. The UE includes a transceiver configured to receive, on a first cell, a synchronization signal associated with first quasi-collocation properties on a first cell, transmit, on the first cell, a PRACH in response to the reception of the synchronization signal, and receive, on the first cell, a SS/PBCH block associated with second quasi-collocation properties in response to the transmission of the PRACH.

In yet another embodiment, a base station is provided. The base station includes a transceiver configured to transmit, on a first cell, a synchronization signal associated with first quasi-collocation properties on a first cell; receive, on the first cell, a PRACH associated with the synchronization signal; and transmit, on the first cell, a SS/PBCH block associated with second quasi-collocation properties in response to the reception of the PRACH.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIGS. 4A and 4B illustrate an example of a wireless transmit and receive paths according to embodiments of the present disclosure;

FIG. 5 illustrates an example of a transmitter structure for beamforming according to embodiments of the present disclosure;

FIG. 6 illustrates an example of a transmitter structure for physical downlink shared channel (PDSCH) in a subframe according to embodiments of the present disclosure;

FIG. 7 illustrates an example of a receiver structure for PDSCH in a subframe according to embodiments of the present disclosure;

FIG. 8 illustrates an example of a transmitter structure for physical downlink control channel (PDCCH) in a subframe according to embodiments of the present disclosure;

FIG. 9 illustrates an example of a receiver structure for PDCCH in a subframe according to embodiments of the present disclosure;

FIG. 10 illustrates diagrams of example satellite footprints according to embodiments of the present disclosure; and

FIG. 11 illustrates a diagram of example satellite footprints according to embodiments of the present disclosure;

FIG. 12 illustrates a flowchart of an example UE procedure for transmitting a physical random access channel (PRACH) according to embodiments of the present disclosure;

FIG. 13 illustrates a flowchart of an example UE procedure for transmitting a sequence-based signal according to embodiments of the present disclosure;

FIG. 14 illustrates a flowchart of an example UE procedure for receiving configurations according to embodiments of the present disclosure;

FIG. 15 illustrates a flowchart of an example UE procedure for receiving system information blocks (SIBs) according to embodiments of the present disclosure;

FIG. 16 illustrates a flowchart of an example UE procedure for receiving low power synchronization signal (LP-SS) according to embodiments of the present disclosure;

FIG. 17 illustrates a flowchart of an example UE procedure for attempting to receive LP-SS according to embodiments of the present disclosure; and

FIG. 18 illustrates a flowchart of an example UE procedure for receiving synchronization signal blocks (SSBs) according to embodiments of the present disclosure;

### DETAILED DESCRIPTION

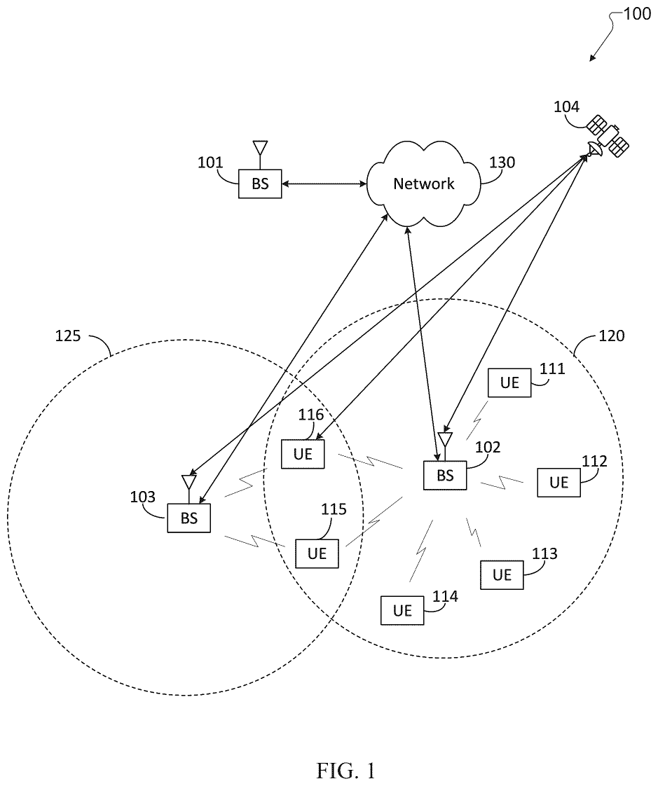

FIGS. 1-18 discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [REF1] 3GPP TS 38.211 v18.1.0, “NR; Physical channels and modulation;” [REF2] 3GPP TS 38.212 v18.1.0, “NR; Multiplexing and channel coding;” [REF3] 3GPP TS 38.213 v18.1.0, “NR; Physical layer procedures for control;” [REF4] 3GPP TS 38.214 v18.1.0, “NR; Physical layer procedures for data;” [REF5] 3GPP TS 38.321 v18.0.0, “NR; Medium Access Control (MAC) Protocol Specification;” and [REF6] 3GPP TS 38.331 v18.0.0, “NR; Radio Resource Control (RRC) Protocol Specification.”

FIGS. 1-18 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of the present disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3 generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As discussed in greater detail below, the wireless network 100 may have communications facilitated via one or more communication satellite(s) 104 that may be in orbit over the earth. The communication satellite(s) 104 can communicate directly with the BSs 102 and 103 to provide network access, for example, in situations where the BSs 102 and 103 are remotely located or otherwise in need of facilitation for network access connections beyond or in addition to traditional fronthaul and/or backhaul connections. The BSs can also be on board the communication satellite(s) 104. Various of the UEs (e.g., as depicted by UE 116) may be capable of at least some direct communication and/or localization with the communication satellite(s) 104.

A non-terrestrial network (NTN) refers to a network, or segment of networks using RF resources on board a communication satellite (or unmanned aircraft system platform) (e.g., communication satellite(s) 104). Considering the capabilities of providing wide coverage and reliable service, an NTN is envisioned to ensure service availability and continuity ubiquitously. For instance, an NTN can support communication services in unserved areas that cannot be covered by conventional terrestrial networks, in underserved areas that are experiencing limited communication services, for devices and passengers on board moving platforms, and for future railway/maritime/aeronautical communications, etc.

As described in more detail below, one or more of the UEs 111-116 include circuitry, programing, or a combination thereof for network power adaptation. In certain embodiments, one or more of the BSs 101-103 include circuitry, programing, or a combination thereof to support network power adaptation.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

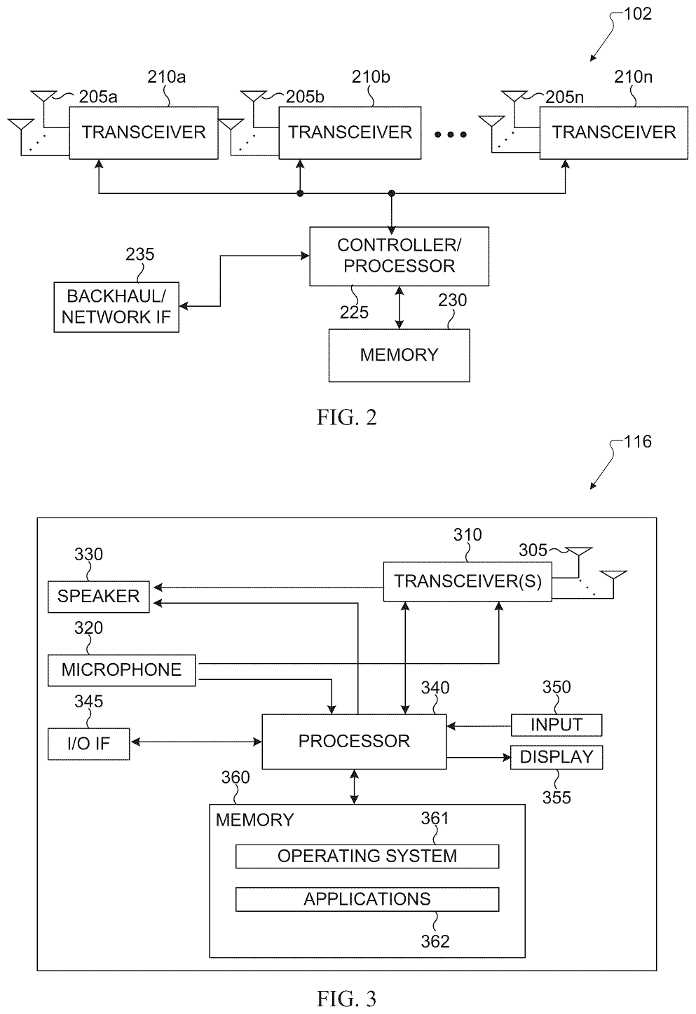

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of the present disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for uplink control signaling for power adaptation. Any of a wide variety of other functions could be supported in the gNB 102 by the controller/processor 225.

The controller/processor 225 is also capable of executing programs and other processes resident in the memory 230, such as processes to support uplink control signaling for power adaptation. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for uplink control signaling for power adaptation as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

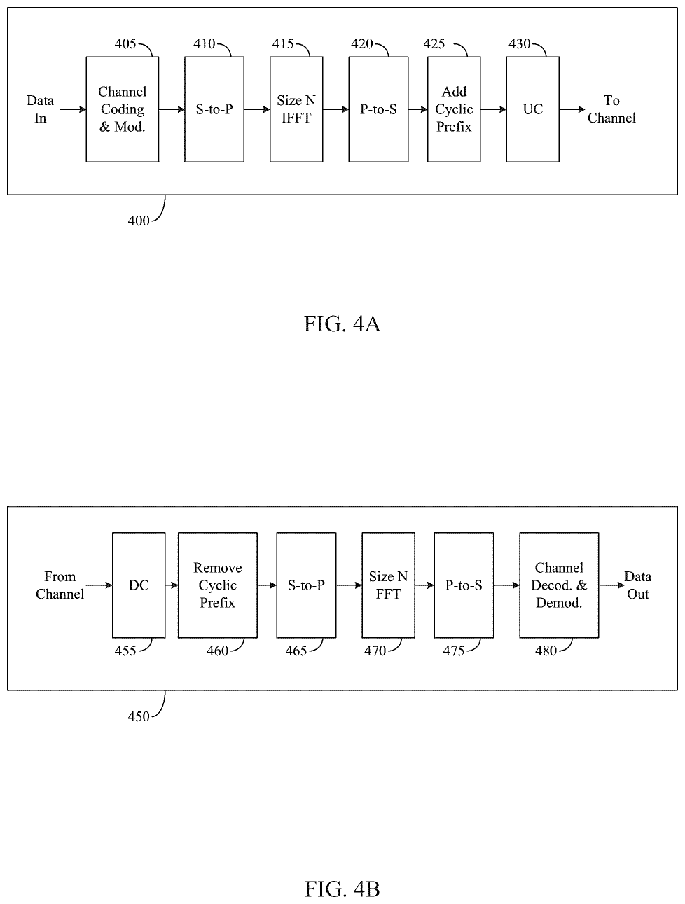

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 is configured for uplink control signaling for power adaptation as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB and the UE. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

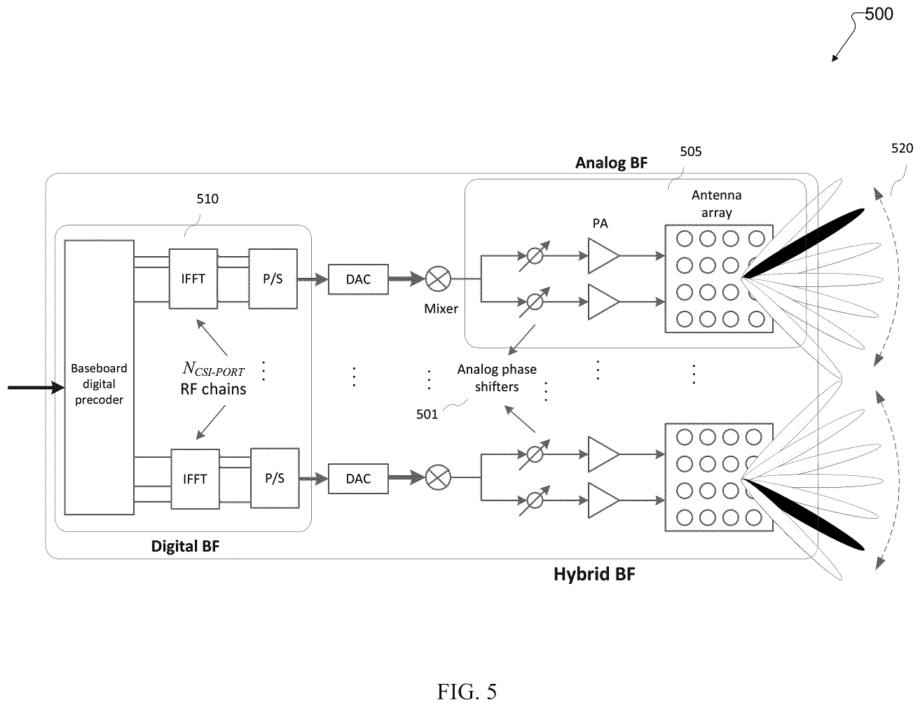

FIG. 5 illustrates an example of a transmitter structure 500 for beamforming according to embodiments of the present disclosure. In certain embodiments, one or more of gNB 102 or UE 116 includes the transmitter structure 500. For example, one or more of antenna 205 and its associated systems or antenna 305 and its associated systems can be included in transmitter structure 500. This example is for illustration only and other embodiments can be used without departing from the scope of the present disclosure.

Accordingly, embodiments of the present disclosure recognize that Rel-14 LTE and Rel-15 NR support up to 32 channel state information reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 5. Then, one CSI-RS port can be mapped onto a large number of antenna elements that can be controlled by a bank of analog phase shifters 501. One CSI-RS port can then correspond to one sub-array which produces a narrow analog beam through analog beamforming 505. This analog beam can be configured to sweep across a wider range of angles 520 by varying the phase shifter bank across symbols or slots/subframes. The number of sub-arrays (equal to the number of RF chains) is the same as the number of CSI-RS ports N_{CSI-PORT}. A digital beamforming unit 510 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 500 of FIG. 5 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 5 is also applicable to higher frequency bands such as >52.6 GHz (also termed frequency range 4 or FR4). In this case, the system can employ only analog beams. Due to the O2 absorption loss around 60 GHz frequency (˜10 dB additional loss per 100 m distance), a larger number and narrower analog beams (hence a larger number of radiators in the array) are essential to compensate for the additional path loss.

The text and figures are provided solely as examples to aid the reader in understanding the disclosure. They are not intended and are not to be construed as limiting the scope of this disclosure in any manner. Although certain embodiments and examples have been provided, it will be apparent to those skilled in the art based on the disclosures herein that changes in the embodiments and examples shown may be made without departing from the scope of this disclosure.

The below flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

In the following, an italicized name for a parameter implies that the parameter is provided by higher layers.

DL transmissions or UL transmissions can be based on an OFDM waveform including a variant using DFT precoding that is known as DFT-spread-OFDM that is typically applicable to UL transmissions.

A unit for DL signaling or for UL signaling on a cell is referred to as a slot and can include one or more symbols. A bandwidth (BW) unit is referred to as a resource block (RB). One RB includes a number of sub-carriers (SCs). For example, a slot can have duration of one millisecond and an RB can have a bandwidth of 180 kHz and include 12 SCs with inter-SC spacing of 15 kHz. A sub-carrier spacing (SCS) can be determined by a SCS configuration μ as 2^{μ}·15 kHz. A unit of one sub-carrier over one symbol is referred to as resource element (RE). A unit of one RB over one symbol is referred to as physical RB (PRB).

DL signaling include physical downlink shared channels (PDSCHs) conveying information content, physical downlink control channels (PDCCHs) conveying DL control information (DCI), and reference signals (RS). A PDCCH can be transmitted over a variable number of slot symbols including one slot symbol and over a number of control channel elements (CCEs) from a predetermined set of numbers of CCEs referred to as CCE aggregation level within a control resource set (CORESET) as described in [REF1] and [REF3].

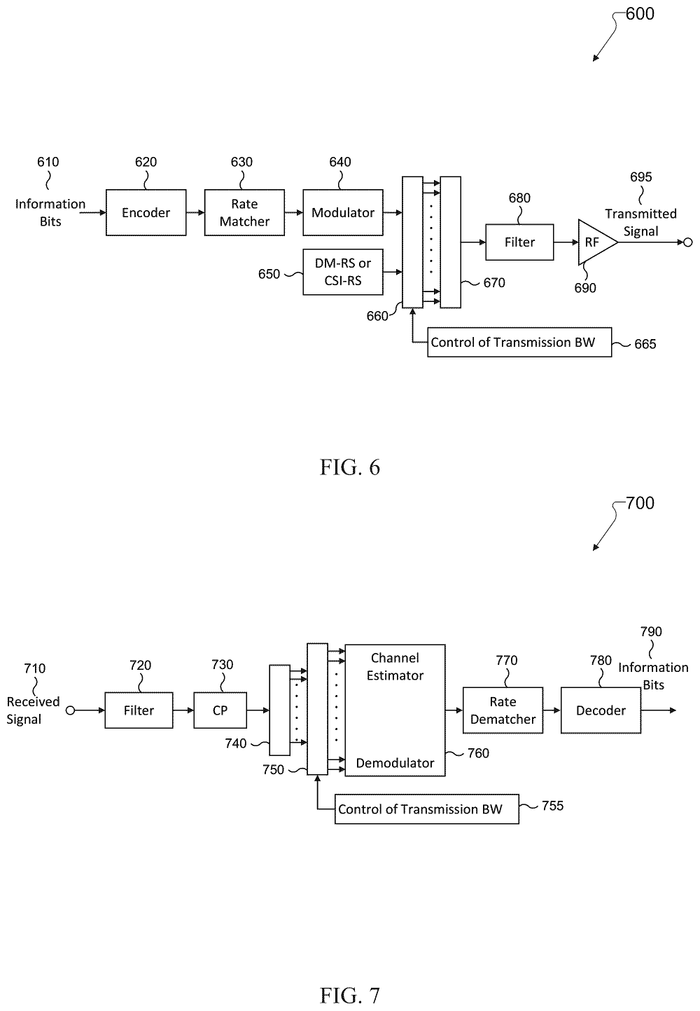

FIG. 6 an example of a transmitter structure 600 for PDSCH in a subframe according to embodiments of the present disclosure. For example, transmitter structure 600 can be implemented in gNB 103 of FIG. 1. This example is for illustration only and other embodiments can be used without departing from the scope of the present disclosure.

Information bits, such as DCI bits or data bits 610, are encoded by encoder 620, rate matched to assigned time/frequency resources by rate matcher 630, and modulated by modulator 640. Subsequently, modulated encoded symbols and demodulation reference signal (DM-RS) or CSI-RS 650 are mapped to REs 660 by RE mapping unit 665, an inverse fast Fourier transform (IFFT) is performed by filter 670, a cyclic prefix (CP) is added by CP insertion unit 680, and a resulting signal is filtered by filter 690 and transmitted by a radio frequency (RF) unit 695.

FIG. 7 illustrates an example of a receiver structure 700 for PDSCH in a subframe according to embodiments of the present disclosure. For example, receiver structure 700 can be implemented by the UE 116 of FIG. 3. This example is for illustration only and other embodiments can be used without departing from the scope of the present disclosure.

A received signal 710 is filtered by filter 720, a CP removal unit removes a CP 730, a filter 740 applies a fast Fourier transform (FFT), RE de-mapping unit 750 de-maps REs selected by BW selector unit 755, received symbols are demodulated by a channel estimator and a demodulator unit 760, a rate de-matcher 770 restores a rate matching, and a decoder 580 decodes the resulting bits to provide information bits 790.

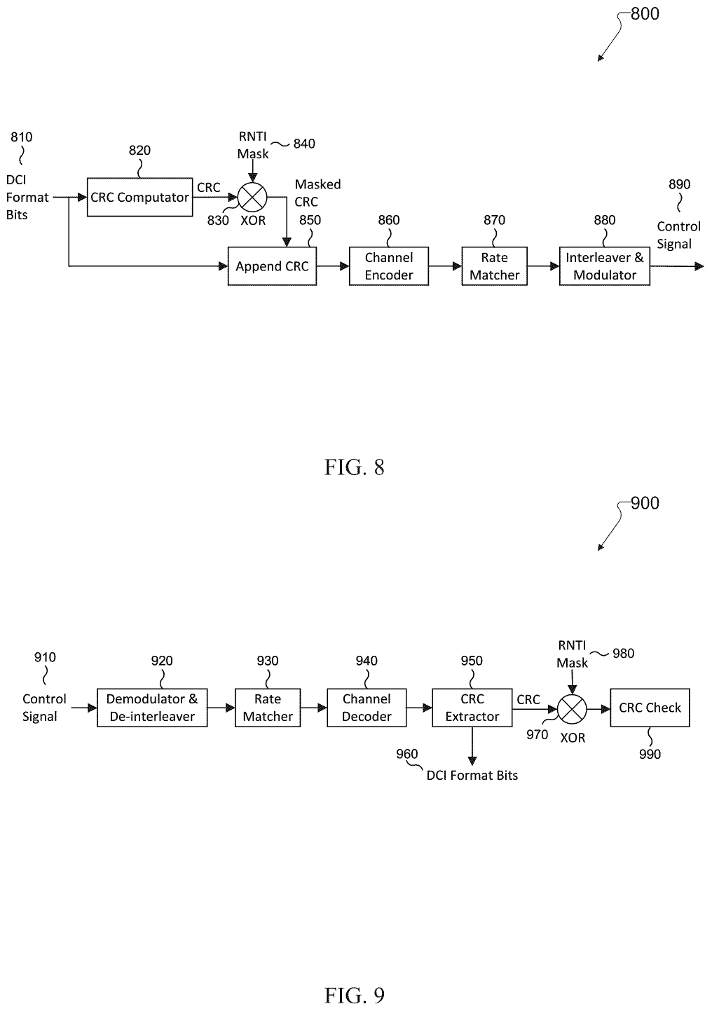

FIG. 8 illustrates an example of a transmitter structure 800 for PDCCH in a subframe according to embodiments of the present disclosure. For example, transmitter structure 800 can be implemented in gNB 102 of FIG. 1. This example is for illustration only and other embodiments can be used without departing from the scope of the present disclosure.

A gNB (e.g., the gNB 102) separately encodes and transmits each DCI format in a respective PDCCH. When applicable, a radio network temporary identifier (RNTI) for a UE (e.g., the UE 116) that a DCI format is intended for masks a cyclic redundancy check (CRC) of the DCI format codeword in order to enable the UE to identify the DCI format. For example, the CRC can include 24 bits and the RNTI can include 16 bits or 24 bits. The CRC of (non-coded) DCI format bits 810 is determined using a CRC computation unit 820, and the CRC is masked using an exclusive OR (XOR) operation unit 830 between CRC bits and RNTI bits 840. The XOR operation is defined as XOR (0,0)=0, XOR (0,1)=1, XOR (1,0)=1, XOR (1,1)=0. The masked CRC bits are appended to DCI format information bits using a CRC append unit 850. An encoder 860 performs channel coding, such as polar coding, followed by rate matching to allocated resources by rate matcher 870. Interleaving and modulation units 880 apply interleaving and modulation, such as QPSK, and the output control signal 890 is transmitted.

FIG. 9 illustrates an example of a receiver structure 900 for PDCCH in a subframe according to embodiments of the present disclosure. For example, receiver structure 900 can be implemented by any of the UEs 111-116 of FIG. 1. This example is for illustration only and other embodiments can be used without departing from the scope of the present disclosure.

A received control signal 910 is demodulated and de-interleaved by a demodulator and a de-interleaver 920. A rate matching applied at a gNB transmitter is restored by rate matcher 930, and resulting bits are decoded by decoder 940. After decoding, a CRC extractor 950 extracts CRC bits and provides DCI format information bits 960. The DCI format information bits are de-masked 970 by an XOR operation with a RNTI 980 (when applicable) and a CRC check is performed by unit 990. When the CRC check succeeds (check-sum is zero), the DCI format information bits are regarded to be valid. When the CRC check does not succeed, the DCI format information bits are regarded to be invalid.

DCI can serve several purposes. A DCI format includes information elements (IEs) and is typically used for scheduling a PDSCH (DL DCI format) or a PUSCH (UL DCI format) transmission. A DCI format includes cyclic redundancy check (CRC) bits in order for a UE to confirm a correct detection. A DCI format type is identified by a radio network temporary identifier (RNTI) that scrambles the CRC bits. For a DCI format scheduling a PDSCH or a PUSCH for a single UE with RRC connection to a gNB, the RNTI is a cell RNTI (C-RNTI) or another RNTI type such as a modulation and coding scheme (MCS)-C-RNTI. For a DCI format scheduling a PDSCH conveying system information (SI) to a group of UEs, the RNTI is a system information RNTI (SI-RNTI). For a DCI format scheduling a PDSCH providing a response to a random access (RA) from a group of UEs, the RNTI is a random access RNTI (RA-RNTI). For a DCI format scheduling a PDSCH providing contention resolution in Msg4 of a RA process, the RNTI is a temporary C-RNTI (TC-RNTI). For a DCI format scheduling a PDSCH paging a group of UEs, the RNTI is a paging RNTI (P-RNTI). For a DCI format providing transmission power control (TPC) commands to a group of UEs, the RNTI is a transmit power control radio network temporary identifier (TPC-RNTI), and so on. Each RNTI type is configured to a UE through higher layer signaling. A UE typically decodes at multiple candidate locations for PDCCH transmissions.

For each DL bandwidth part (BWP) indicated to a UE in a serving cell, the UE can be provided by higher layer signaling with P≤3 control resource sets (CORESETs). For each CORESET, the UE is provided a CORESET index p, 0≤p<12, a DM-RS scrambling sequence initialization value, a precoder granularity for a number of resource element groups (REGs) in the frequency domain where the UE can expect use of a same DM-RS precoder, a number of consecutive symbols for the CORESET, a set of resource blocks (RBs) for the CORESET, control channel element (CCE)-to-resource element group (REG) mapping parameters, an antenna port quasi co-location, from a set of antenna port quasi co-locations, indicating quasi co-location information of the DM-RS antenna port for PDCCH reception in a respective CORESET, and an indication for a presence or absence of a transmission configuration indication (TCI) field for DCI format 1_1 transmitted by a PDCCH in CORESET p.

For each DL BWP configured to a UE in a serving cell, the UE is provided by higher layers with S≤10 search space sets. For each search space set from the S search space sets, the UE is provided a search space set index s, 0≤s<40, an association between the search space set s and a CORESET p, a PDCCH monitoring periodicity of kₛ slots and a PDCCH monitoring offset of oₛ slots, a PDCCH monitoring pattern within a slot, indicating first symbol(s) of the CORESET within a slot for PDCCH monitoring, a duration of Tₛ<kₛ slots indicating a number of slots that the search space set s exists, a number of PDCCH candidates Mₛ^{(L)} per CCE aggregation level L, and an indication that search space set s is either a common search space (CSS) set or a UE-specific search space (USS) set. When search space set s is a CSS set, the UE monitors PDCCH for detection of DCI format 2_x, where x ranges from 0 to 7 as described in [REF2], or for DCI formats associated with scheduling broadcast/multicast PDSCH receptions, and for DCI format 0_0 and DCI format 1_0.

A UE determines a PDCCH monitoring occasion on an active DL BWP from the PDCCH monitoring periodicity, the PDCCH monitoring offset, and the PDCCH monitoring pattern within a slot. For search space set s, the UE determines that a PDCCH monitoring occasion(s) exists in a slot with number n_{s,f}^{μ} in a frame with number n_{f} if (n_{f}·Nₛₗₒₜ^{frame,μ}+n_{s,f}^{μ}−oₛ) mod kₛ=0. The UE monitors PDCCH candidates for search space set s for Tₛ consecutive slots, starting from slot n_{s,f}^{μ}, and does not monitor PDCCH candidates for search space set s for the next kₛ−Tₛ consecutive slots. The UE determines CCEs for monitoring PDCCH according to a search space set based on a search space equation as described in [REF3].

A UE can be configured for operation with carrier aggregation (CA) for PDSCH receptions over multiple cells (DL CA) or for PUSCH transmissions over multiple cells (UL CA). The UE can also be configured multiple transmission-reception points (TRPs) per cell via indication (or absence of indication) of a coresetPoolIndex for CORESETs where the UE receives PDCCH/PDSCH from a corresponding TRP as described in [REF3] and [REF4].

In the following, unless otherwise explicitly noted, providing a parameter value by higher layers includes providing the parameter value by a system information block (SIB), such as a SIB1, or by a common RRC signaling, or by UE-specific RRC signaling.

The following descriptions may evaluate that a satellite implements a transparent payload, but are also directly applicable to regenerative payloads.

Throughout this disclosure the terms satellite and UAS platform are used interchangeably, and the following descriptions for satellites can be also directly applicable or adapted for any aerial platform.

The following descriptions and embodiments discuss a NTN but are also directly applicable to a TN, and the functionalities of a satellite in NTN can be same as the functionalities of a gNB in a TN, or can be adapted taking into account that the footprint of a or Low Earth Orbit (LEO) satellite moves over time because of the movement of the satellite respect to the earth. For a geostationary equatorial orbit (GEO) satellite, the footprint is fixed, similar to a gNB in TN.

Throughout this disclosure the terms satellite or serving gNB are used interchangeably to refer to any component (or collection of components) configured to provide remote terminals with wireless access to a network (e.g., the network 130). Descriptions directly apply to satellite network architectures with transparent payload and with non-transparent payload, and to any aerial platforms such as unmanned aerial service (UAS) platforms, as well as to terrestrial networks.

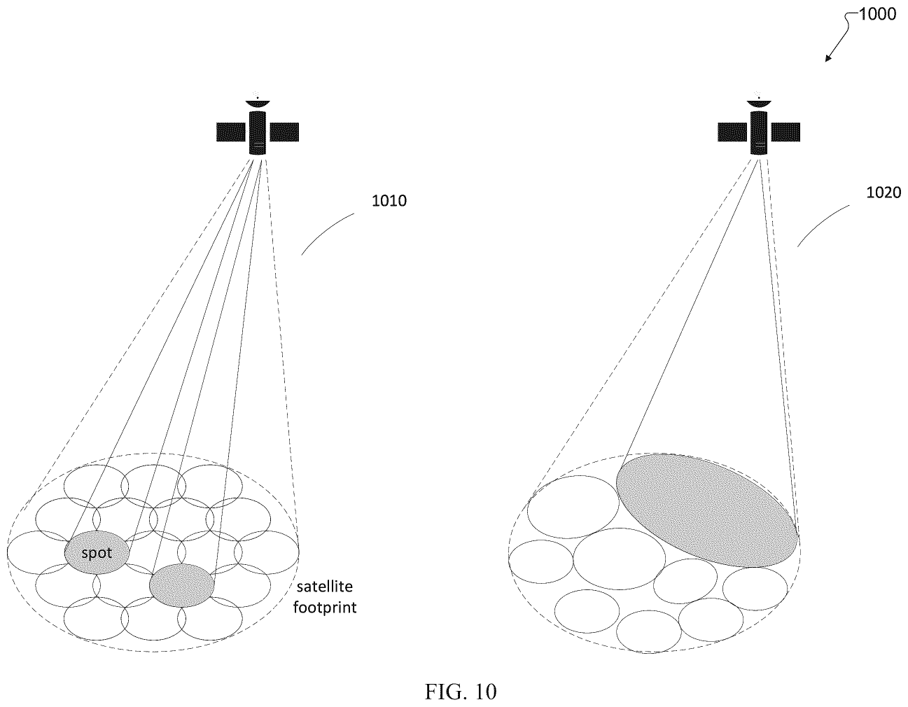

FIG. 10 illustrates diagrams of example satellite footprints 1010 and 1020, respectively, according to embodiments of the present disclosure. For example, satellite footprints 1010 and 1020, respectively, can serve any of the UEs 111-116 of FIG. 1. This example is for illustration only and other embodiments can be used without departing from the scope of the present disclosure.

A NTN is a network using RF resources on board satellites or UAS platforms. The NTN includes satellites that can be GEO satellites served by one or several satellite-gateways deployed across the satellites targeted coverage or LEO satellites served successively by one or several satellite-gateways at a time, a radio link between a satellite-gateway and the satellite or UAS platform, and a radio link between the UE and the satellite or UAS platform. A satellite or UAS platform may implement either a transparent payload, wherein the NTN payload transparently forwards the radio protocol received from the UE (via the service link) to the NTN Gateway (via the feeder link) and vice-versa, or a regenerative payload with onboard processing. An NTN gateway may serve multiple NTN payloads, and an NTN payload may be served by multiple NTN gateways. The satellite or UAS platform typically generates several beams over a service area or satellite footprint bounded by its field of view. The satellite footprint depends on the onboard antenna diagram and elevation angle. The footprint of a beam or a beam spot can have an elliptic shape and be evaluated for some aspects as a cell in terrestrial networks.

Beams over a satellite footprint can be generated by using multi-feed reflector antennas or phased-array antennas at the satellite. GEO satellites are usually equipped with multi-feed reflector antennas, while phased-array antennas are used for LEO satellites because of their wide-angle coverage capabilities. In order to suppress interference, different frequency bands and orthogonal polarizations may be used for the different beams, and reuse of the frequency bands would be among sufficiently isolated beams to guarantee sufficient system capacity. For LEO satellites, the coverage area and the propagation channel characteristics changes due to the fast movement of the satellites, requiring a fast adaptation of resource allocation during connected and non-connected modes. Because of the large satellite footprint, traffic can be unequally distributed within the satellite footprint, including areas with high traffic and usually large areas with sparse or no traffic. Limited payload power and feeder link bandwidth limit the number of satellite beams that can be active simultaneously with a nominal equivalent isotropic radiated power (EIRP) density per beam at any given time. Such constraints demand solutions that minimize energy consumption and avoid or at least minimize interference between transmissions or receptions in different beams. Thus, it is necessary to flexibly control resources in the multiple beams of a satellite footprint in time, frequency, space or power domain to optimize performance while maintaining coverage.

One technique for controlling transmission power or transmission/reception time interval, as well as antenna direction or frequency band, is beam hopping. Beam hopping can provide an efficient allocation of resources based on dynamic traffic needs within a satellite footprint. With reference to FIG. 10, within the satellite footprint there can be a number of cells or spots and a beam provided by a given NTN-payload can cover one cell or spot. The satellite uses a number of beams over the satellite footprint to serve users in corresponding cells for a given time period. For example, the satellite footprint can include a number N of cells or spots, and the satellite at any given time activates a number M of beams, with M<N, or activates N beams. When the traffic over the satellite footprint is expected to be approximately equal distributed or there is a need to provide a same level of coverage in the satellite footprint, the satellite can use beams of approximately same width over the whole footprint. In 1010, the satellite uses beams of same width over the satellite footprint, and over time, the satellite changes the cells that are served by activating different beams in corresponding different areas of the satellite footprint, and beams can hop from one cell to another cell within the satellite footprint. When traffic over the satellite footprint is unequally distributed, the satellite can use beams with different beam widths over different areas of the satellite footprint. In 1020, the satellite uses a large beam over one area of the footprint, for example an area with low traffic, and uses smaller beam widths on other areas with higher traffic. Thus, the satellite can flexibly allocate beam resources in different areas of the satellite footprint and change the distribution of the capacity in different beams over the satellite footprint. Adaptation of the beams within the satellite footprint is subject to a total transmit power of the satellite, and the beam hopping technique is often referred as power sharing. The total transmit power of the satellite depends on the type of satellite and on configuration that may allow different settings in one or more of time/frequency/spatial domains.

Throughout this disclosure the term beam hopping is generally used to indicate the operation of adapting beams over the satellite footprint in one or more of time/frequency/spatial/power domains, including switching on and off a beam, or using beams with different widths, or using different beams for different control or data channels over a same area or a partially overlapping area.

Present non-terrestrial networks have limited capability to dynamically adapt a beam within a satellite footprint based on the traffic demand. Adaptation is typically over long time periods, or fixed over a given area. Also, present terrestrial networks have limited capability to dynamically adapt a beam within a footprint based on the traffic demand.

Therefore, a capability of a satellite to improve service or to save energy by a dynamic adaptation of a beam to the traffic types and load, for example switching on and off beams or adapting the transmission power of the beam, is currently limited as there are limited procedures for the satellite to perform dynamic adaptation based on location information within the satellite footprint or the serving.

Before connecting to an NTN cell, a UE (e.g., the UE 116) should have valid global navigation satellite system (GNSS) position, as well as have received valid ephemeris and Common TA parameters broadcasted by the network (e.g., the network 130) for the serving cell. To achieve synchronization, before and during connection to an NTN cell, the UE determines the round-trip time (RTT) between UE and the RP based on the GNSS position, the ephemeris, and the Common TA parameters, and autonomously pre-compensate the TTA for the RTT between the UE and the RP as illustrated in FIG. 16.14.2.1-1 (clause 4.3 of [REF1]). The UE also determines the frequency Doppler shift of the service link, and autonomously pre-compensates for it in the uplink transmissions, by evaluating UE position and the ephemeris. If the UE does not have a valid GNSS position and/or valid ephemeris and Common TA, the UE does not transmit until both are regained. In connected mode, the UE continuously updates the Timing Advance and frequency pre-compensation. The UE can be configured to report Timing Advance during RA procedures or in connected mode. In connected mode, Timing Advance reporting can be event-triggered. Upon network request, the UE reports its coarse UE location information (most significant bits of the GNSS coordinates, ensuring an accuracy in the order of 2 km) to the next generation radio access network (NG-RAN) if available.

A satellite would provide coverage over a certain area by transmitting multiple synchronization signal/physical broadcast channel (SS/PBCH) blocks with different beams, also referred to as quasi-collocation properties, and the UE typically would acquire the SS/PBCH block associated with the quasi-collocation properties that best match the ones of the UE. Then, expecting beam reciprocity for the DL and UL transmissions, the UE transmits physical random access channel (PRACH) according to a spatial setting that is determined from the detected SS/PBCH block. To minimize an overhead associated with the SS/PBCH blocks, the network transmits a SS/PBCH block with a wide beam to cover a corresponding wide area on the satellite footprint, while the UE, to compensate for a DL/UL coverage imbalance, would typically transmit a PRACH with a narrower beam that is unknown to the satellite. The UE location is also unknown to the satellite.

In order to optimize beam hopping and enable a network to flexibly allocate beam resources in different areas of a satellite footprint and effectively change the distribution of the capacity in different beams, the network may allocate beam resources based on the location of UEs within the satellite footprint area. The network may transmit multiple SS/PBCH blocks with different beams over the satellite footprint, and then based on the UE's location the network adapts beam resources. The UE can provide its location during RA procedures or in connected mode, and the network can adapt the beam resources. For example, when a UE provides its location during RA procedures, the network may activate a beam to cover the area where the UE is located or scale the transmission power of a beam that is already used to illuminate that area, and, in areas where no UEs have attempted to connect, may adapt beam resources by disactivating beams or by scaling the transmission powers of the beam respect to an initial or previous configuration or by activating a beam that would cover a larger area of the footprint, or a combination thereof.

An adaptation of beam resources by a gNB based on a location information provided by one or more UEs can affect UEs in RRC_IDLE and RRC_INACTIVE states and/or UEs in RRC_CONNECTED state. For example, upon reception of location information by one or more UEs, the gNB activates or deactivates a beam for RA procedures, or the gNB activates or deactivates a beam for UEs in RRC_CONNECTED state, or the gNB activates a beam in an area that includes UE(s) that provided location information to serve the UE(s) while in RRC_CONNECTED state, or the gNB activates a new beam over a first area and/or deactivates one or more existing beams over a second area, and first and second areas may (partially) overlap.

Therefore, embodiments of the present disclosure recognize that there is a need to enable a UE to provide a location information to a gNB while in RRC_IDLE state or RRC_INACTIVE state or RRC_CONNECTED state.

Embodiments of the present disclosure further recognize that there is another need to determine procedures for beam adaptation in response to a location information provided by a UE.

Embodiments of the present disclosure further recognize that there is another need for a gNB to identify whether a UE is capable of providing its location before the UE establishes an RRC connection with the gNB.

A UE, capable of providing its location information, can provide location information by a physical channel or higher layer signal.

A UE can be indicated by a serving gNB by higher layers to provide location information, and can also be provided resources for physical uplink control channel (PUCCH) transmissions providing location information.

In a first approach, a UE can provide location information through resource selection for a corresponding PUCCH transmission. In order for the UE to provide N bits of location information, the UE needs to be provided 2^{N} PUCCH resources to select from for a PUCCH transmission. Those resources can be common among UEs and be provided by a SIB or by UE-specific RRC signaling, or can be UE-specific resources provided by UE-specific RRC signaling. For example, the UE can be provided 8 PUCCH resources to indicate respective 3 bits of information.

In a second approach, a UE can provide location information through a PUCCH transmission that includes information bits. If the number of information bits is not larger than 2, a serving gNB can provide to the UE a PUCCH resource, associated for example with PUCCH format 1, for the UE to use for a PUCCH transmission providing location information. If the number of information bits is larger than 2, as it is likely required for more accurate location information, the serving gNB can provide to the UE a PUCCH resource, associated for example with PUCCH format 2, 3, or 4, or a new PUCCH format that includes location information, for the UE to use for a PUCCH transmission providing location information.

For example, when in response to a PUSCH transmission scheduled by a random access response (RAR) UL grant a UE has not been provided a C-RNTI, attempts to detect a DCI format 1_0 with CRC scrambled by a corresponding TC-RNTI scheduling a PDSCH that includes a UE contention resolution identity, and receives the PDSCH with the UE contention resolution identity, the UE transmits hybrid automatic repeat request acknowledgement (HARQ-ACK) information in a PUCCH that also includes additional bits for a location information.

In a third approach, a UE can provide location information together with other uplink control information (UCI), such as a HARQ-ACK information or a CSI report or a scheduling request (SR), in a PUCCH or a PUSCH transmission, thereby introducing location information as a new UCI type.

In a fourth approach, the UE can provide location information by higher layers, such as a MAC control element (CE), in a PUSCH transmission. For example, a new MAC CE can be defined for location information where the UE can indicate the location information.

The approaches herein can be separately configured or combined where, for example, when a UE reports a coarse location information, the first approach can be used; otherwise, other approaches can be used. For example, some approaches can be configured for the UE in RRC_IDLE or RRC_INACTIVE state and others for the UE in RRC_CONNECTED state.

In one example, a serving gNB can provide to a UE first PUCCH resources, for example according to the first approach and via a SIB, for the UE to transmit a PUCCH with location information for the purpose of requesting uplink and downlink requests in the area where the UE is located. This would be a type of wake-up signal provided by the UE for the gNB that also includes location information. Alternatively, the serving gNB can provide to the UE PRACH resources for the UE to transmit a PRACH for the purpose of waking-up the gNB and provide second PUCCH resources or enable use of a MAC CE for the purpose of the UE providing location information to the gNB to activate a beam in a given area.

In one example, a serving gNB (e.g., the gNB 102) can provide to a UE first PUCCH resources for the UE to transmit a PUCCH for the purpose of requesting uplink and downlink resources in the area where the UE is located. This would be a type of wake-up signal for the gNB that does not include location information. After receiving the wake-up signal, the serving gNB can provide second PUCCH resources, for example according to the first approach and via a SIB, for the UE to transmit a PUCCH with location information, or enable use of a MAC CE for the purpose of the UE providing location information to the gNB. The UE can transmit the wake-up signal using the first PUCCH resources and the location information using the second PUCCH resources.

A use of first and second PUCCH resources may be subject to a minimum and/or configured time interval between transmission of the wake-up signal in the first PUCCH resources and transmission of the location information in the second PUCCH resources.

After a UE (e.g., the UE 116) transmits a PUCCH providing wake-up information, the UE monitors a PDCCH according to indicated search space sets for detection of a DCI format indicating a request for the UE to report location information or indicating an acknowledgment of reception of the wake-up information. After reception of the DCI format, the UE transmits the location information using second PUCCH resources.

After a UE transmits a first PUCCH providing wake-up information, the UE starts a RA procedure by transmitting a PRACH, and transmits a location information in a second PUCCH that also provides HARQ-ACK information in response to a PDSCH reception after transmission of a Msg3 PUSCH or a MsgA PUSCH.

A location information can be provided to the serving gNB in a PUSCH. For example, after a UE transmits a PUCCH providing wake-up information, the UE starts a RA procedure by transmitting a PRACH, and transmits a location information in a Msg3 PUSCH scheduled by a random access response (RAR) UL grant, or in a MsgA.

A determination of a power for the PUCCH transmission or the PUSCH transmission that includes a location information according to the approaches herein, for example as described in [REF3], may exclude a closed-loop power control component that is based on accumulation of TPC commands because a UE may not have transmitted or received for a time period that is longer than a time period required for correlated short term channel fading characteristics and a value of the closed-loop power control component may then be outdated. Alternatively, a UE can be provided by higher layers a time period, for example in slots of the active BWP or in slot of a reference numerology or in absolute time such as milliseconds, where the UE sets to 0 the value of the closed loop power control component if the UE has not received any TPC commands or if the UE did not transmit during the time period. A closed-loop power control component value is not available for the PUCCH transmission during a RA procedure before an RRC connection.

For a satellite or a serving gNB to adapt coverage over a cell, hence adapting network operations in different areas of the cell, the satellite or serving gNB determines whether there is a need to provide coverage in areas of the cell that are currently out-of-coverage. For example, the satellite or serving gNB provides coverage in a first area of the cell by using one or multiple beams, wherein the first area does not include a second area, and determines whether to provide coverage in the second area of the cell by transmitting an indication in the second area, such as a first low power synchronization signal (LP-SS) or an SSB, and monitoring for a response to the indication, such as a second LP-SS or a PRACH. A UE in the second area of the cell may monitor for the indication and may transmit in response to the indication based on at least a UE capability associated with the reception of the indication. Such UE capability may also be mandatory. After reception of the indication, such as the first LP-SS or the SSB, in the second area, the UE may transmit an uplink signal or channel, such as the second LP-SS or a PRACH or a PUCCH, to indicate to the satellite or serving gNB its presence and/or its request to be provided coverage.

Therefore, embodiments of the present disclosure further recognize that there is a need to define signaling and procedures for a serving gNB or satellite to determine whether to provide coverage in an area by detecting a presence of a UE in the area.

Embodiments of the present disclosure further recognize that there is another need for the UE to receive, based on a UE capability, the signalling from the serving gNB or satellite.

The exemplary Synchronization Signal and PBCH block (SSB) in NR includes primary and secondary synchronization signals (PSS, SSS), each occupying 1 symbol and 127 subcarriers, and PBCH spanning across 3 OFDM symbols and 240 subcarriers. The time locations of SSBs within a half-frame are determined by Sub-Carrier Spacing (SCS), and the periodicity of the half-frames where SSBs are transmitted is configured by the network. During a half-frame, different SSBs may be transmitted in different spatial directions (i.e. using different beams, spanning the coverage area of a cell). Within the frequency span of a carrier, multiple SSBs can be transmitted. The PSS and SSS include the cell ID and are used by the UE for time-frequency synchronization and to obtain symbol-level timing. The SSS and the DM-RS of the PBCH can be used to measure the signal quality of a cell or a beam. The PBCH indicates the slot boundary or frame boundary and also the frame number. The Physical Cell Identifiers (PCIs) of SSBs transmitted in different frequency locations can be same or different. When an SSB is associated with a Remaining Minimum System Information (RMSI), also referred to as system information block 1 (SIB1), the SSB is referred to as Cell-Defining SSB (CD-SSB). A serving cell is associated to a CD-SSB located on the synchronization raster. A gNB can also configure Non-Cell-Defining SSBs (NCD-SSBs). For example, for a UE in connected mode, the gNB can configure SSB-based radio resource management (RRM) measurements on CD-SSBs and/or NCD-SSBs. When in a serving cell both CD-SSBs and NCD-SSBs are configured, the PCIs of CD-SSBs and NCD-SSBs can be same. The gNB can configure NCD-SSBs for a UE in connected mode for different functionalities, such as radio link monitoring (RLM), bidirectional forwarding detection (BFD), link recovery, random access occasion (RO) selection, in TCI-states or for any other functionality other than RRM measurements. For a UE in idle or inactive mode, the gNB can configure NCD-SSBs that the UE can use to perform measurements; however, to receive SIB the UE needs to use CD-SSBs.

During initial cell search, a UE acquires/detects an SSB transmitted by a gNB. The gNB can transmit multiple SSBs with different quasi-collocation properties, also referred to as beams, and the UE typically acquires the SSB associated with the quasi-collocation properties that best match the ones of the UE. Then, assuming beam reciprocity for DL and UL transmissions, the UE transmits PRACH according to a spatial setting that is determined from the detected SSB. The gNB can transmit CD-SSBs or can also transmit NCD-SSBs with different quasi-collocation properties and the UE can acquire the SSB associated with the best quasi-collocation properties from the transmitted CD-SSBs or NCD-SSBs.

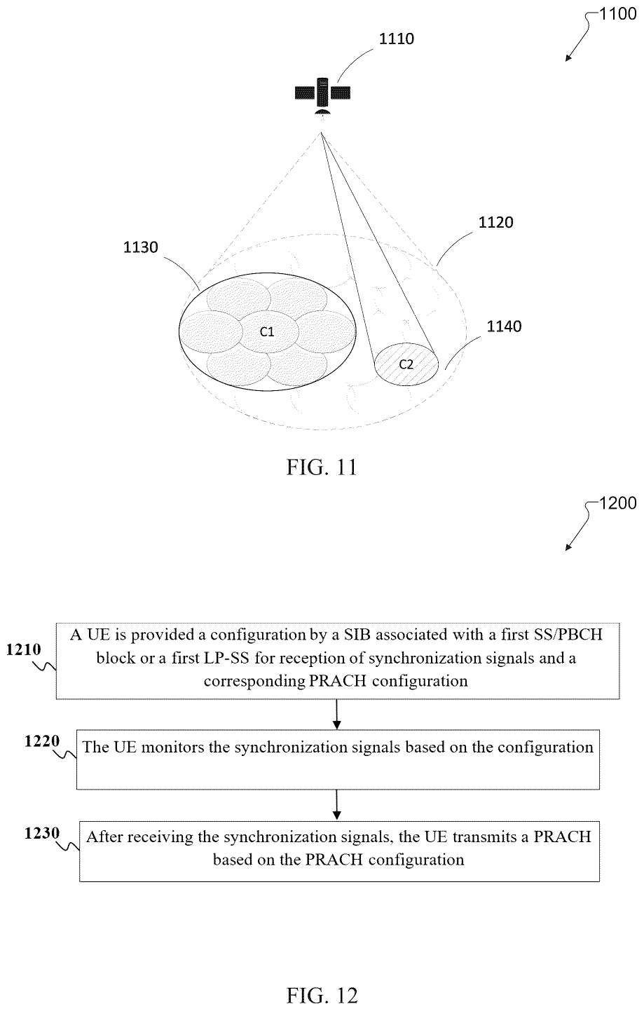

FIG. 11 illustrates a diagram of example satellite footprints 1100 according to embodiments of the present disclosure. For example, satellite footprints 1100 can serve any of the UEs 111-116 of FIG. 1. This example is for illustration only and other embodiments can be used without departing from the scope of the present disclosure.

As illustrated in FIG. 11, a satellite uses a number of beams to provide coverage over a number of areas within a satellite footprint. The satellite footprint can also be referred to as the large cell and the number of areas within the satellite footprint as sub-cells or small cells or, simply, cells. The satellite footprint can include a number N of cells, and the satellite at any given time activates a number M of beams, with M<N, or activates all N beams. When traffic over the satellite footprint is expected to be approximately equally distributed, or when there is a need to provide a same level of coverage in the satellite footprint using beams with approximately same transmit power, the satellite may activate beams of approximately same beam width and, over time, activate different beams in corresponding different areas of the satellite footprint. When traffic over the satellite footprint is unequally distributed, the satellite may provide coverage only in one area of the satellite footprint (1120) and activate one or more beams with same or different beam widths. To determine whether to provide coverage in another area of the satellite footprint, for example in C1 (1130), the satellite or serving gNB first determines whether there are UEs needing service in C1 and then activates one or more beams to provide coverage over C1. The satellite can flexibly allocate beam resources in different areas of the satellite footprint, thus changing the distribution of the capacity in different beams. The operation of adapting beams over the satellite footprint can be in one or more of time/frequency/spatial/power domains, including switching on and off a beam or adapting a transmit power, or using same or different beams for low power synchronization signals (LP-SS), or for normal synchronization signals such as SSBs, or for transmissions and receptions of channels and signals after acquiring synchronization, or for alert signals transmitted by the satellite or serving gNB and requiring a response from the UE.

Similar to NTN, for a TN a serving gNB can provide coverage over an area of a cell and monitor another area of the cell to determine whether there is a need to provide coverage and, if needed, activate a new beam, or adapt an already active beam, for example by adapting a transmit power and/or a beam width and/or a beam direction.

A satellite or a serving gNB may provide coverage in a portion of a cell. For the satellite or serving gNB to adapt coverage over the cell, hence adapting network operations in different areas of the cell, the satellite or the serving gNB determines whether there is a need to provide coverage in areas of the cell that are currently out-of-coverage. For example, the satellite or serving gNB provides coverage in a first area of the cell by using one or multiple beams, wherein the first area does not include a second area, and determines whether to provide coverage in the second area of the cell by transmitting an indication, such as a first LP-SS or an SSB, in the second area and subsequently monitoring for a reception of a response, such as a second LP-SS or a PRACH, to the indication. A UE (e.g., the UE 116) in the second area of the cell may monitor for the indication and may transmit a response to the indication, wherein the response may depend on at least a UE capability associated with the reception of the indication unless such capability is mandatory in the system operation.

In one example, the UE in the second area may perform a cell search procedure, acquire time and frequency synchronization with the cell and detect the Cell ID of that cell based on the primary and secondary synchronization signals, and PBCH demodulation reference signal (DM-RS), located on the synchronization raster or based on a LP-SS that may also provide information for the Cell ID.

The Master Information Block (MIB) on PBCH provides the UE with parameters (e.g. CORESET #0/search space set #0 configurations) for monitoring of PDCCH for scheduling PDSCH that carries the System Information Block 1 (SIB1). PBCH may also indicate that there is no associated SIB1, in which case the UE may be pointed to another frequency from where to search for an SSB that is associated with a SIB1 as well as a frequency range where the UE may expect no SSB associated with SIB1 is present. The indicated frequency range is confined within a contiguous spectrum allocation of the same operator in which SSB is detected.

Prior to the start of monitoring for the indication, the UE needs to acquire information for resources to be monitored. The UE is not connected to the network, the UE needs to read such information in a SIB that the satellite or serving gNB would broadcast over an area that includes the UE location. Alternatively, the resources to be monitored and the associated signal structure may be predefined in the specifications of the system operation of be configured by the network provider or the UE provider.

After reception of the indication, the UE may respond to the indication by transmitting an uplink signal or channel to indicate to the satellite or serving gNB a UE presence and/or a UE request to be provided coverage. The indication by the gNB can be a low power signal, such as a low power synchronization signal that the UE may be able to receive depending on a UE capability. The response, to the indication, by the UE can be a low power signal, such as a wake-up signal.

Therefore, embodiments of the present disclosure further recognize that there is a need to define signaling and procedures for a serving gNB or satellite to determine whether to provide coverage in an area by detecting a presence of a UE in the area.

Embodiments of the present disclosure further recognize that there is another need for the UE to receive, based on a UE capability, the signalling from the serving gNB or satellite.

Throughout this disclosure the terms satellite and UAS platform are used interchangeably, and the following descriptions for satellites can be also directly applicable or adapted for any aerial platform.

Throughout this disclosure the terms satellite or serving gNB or gNB are used interchangeably to refer to any component (or collection of components) configured to provide remote terminals with wireless access to a network. Descriptions equally apply to satellite network architectures with transparent payload and with non-transparent payload, thus gNB functionalities may be implemented at the satellite site or at the NTN gateway site on earth.

The following descriptions and embodiments are directly applicable to TN and NTN, and the functionalities of a satellite in NTN can be same as the functionalities of a gNB in a TN, or can be adapted evaluating mobility aspects due to the relative movement of the satellite, and implementation aspects of a satellite transparent payload or regenerative payload.

A gNB may provide coverage over a cell C by activating one or more beams. A beam can provide coverage over the entire cell C or over a portion of the cell C. The gNB may use a single beam and provide coverage over the entire cell C, or use multiple beams to provide coverage over multiple areas in part of the cell or in the entire cell. For example, the gNB uses a first beam to provide coverage on a first area, and a UE in the first area may expect to receive SSBs or system information or CSI-RS indicated by higher layers, or to transmit PRACH or sounding reference signal (SRS) using resources indicated by higher layers. The gNB uses a second beam for transmissions and receptions over a second area that does not overlap with the first area in order to communicate with UEs in RRC_IDLE or RRC_INACTIVE state and detect a presence of such UEs in the second area. The gNB uses a second beam for transmissions and/or receptions over a second area that overlaps partially or entirely with the first area in order to communicate with UEs in RRC_IDLE or RRC_INACTIVE state that can receive signals or channels from the second beam and cannot from the first beam. During a time interval, the gNB activates only the first beam or a set of first beams, or only the second beam or a set of second beams, or both first and second beam or first and second sets of beams.

To detect a presence of a UE (e.g., the UE 116) in RRC_IDLE and in RRC_INACTIVE state in an area of a cell or in a cell that is not in coverage, a gNB can transmit a downlink signal using a beam over the area of the cell or over the cell, wherein the downlink signal can serve as an indication for the UE to transmit a response to the reception of the downlink signal. After receiving the downlink signal, the UE may transmit in response an uplink signal to inform the gNB of the UE presence in the area of the cell or in the cell that is associated with the beam. In the following, the downlink signal is referred as an early indication (or discovery indication) and the uplink signal in response to the early indication is referred to as an early acknowledgment (or discovery acknowledgment).

In the following, the gNB may provide coverage by using one or multiple beams over a Cell-A or over a portion of the Cell-A, also referred as C1, and may transmit the downlink signal in a Cell-B. The coverage areas of Cell-A and Cell-B can be non-overlapping or the coverage area of Cell-B can be a portion of the coverage area of Cell-A. The gNB may use multiple beams to transmit and receive over Cell-A, and use different beams for different downlink and uplink signalling. In reference to the NTN scenario in FIG. 11, Cell-A refers to the satellite footprint 1120, and the gNB 1110 may use a single beam or multiple beams to transmit and receive over/from Cell-A or a portion of Cell-A 1130, and use another beam to transmit and receive over/from Cell-B 1140. The portion of Cell-A non-overlapping with Cell-B is referred as Cell-A1. The NTN scenario of FIG. 11 also applies to TN with a terrestrial gNB.

In a first approach, a gNB transmits first LP-SS or first SSBs on a first cell or on a first frequency carrier/BWP of the first cell, for example Cell-A, or on a portion of the first cell using a first beam, for example Cell-A1, and transmits second LP-SSs or second SSBs on a second cell, for example Cell-B, or on a second frequency carrier/BWP of the first cell using a second beam. In the following, for brevity, different areas of a cell are considered and the embodiments are directly applicable to different frequency carriers/BWPs of the cell. The gNB can indicate a first configuration for time location and periodicity of the first LP-SS or the first SSBs and a second configuration for time location and periodicity of the second LP-SS or the second SSBs, wherein the first configuration is associated with the first beam and the second configuration is associated with the second beam. Alternatively, those configurations may not be provided and can then be predetermined based on the specifications of the system operation. Different first LP-SS or first SSBs may be transmitted in different spatial directions spanning the coverage area of Cell-A1, and different second LP-SS or second SSBs may be transmitted in different spatial directions spanning the coverage area of Cell-B. The first configuration of the first LP-SS or the first SSBs can be provided by the gNB in a first SIB associated with the first beam and transmitted using the first beam in Cell-A1, or in Cell-A, and the second configuration of the second LP-SS or the second SSBs can be provided by the gNB in a second SIB associated with the second beam and transmitted using the second beam in Cell-B.

A first physical cell ID (PCI) of the first LP-SS or the first SSBs that are associated with the first beam is same as a second PCI of the second LP-SS or the second SSBs that are associated with the second beam. Alternatively, the first PCI of the first LP-SS or the first SSBs that are associated with the first beam is different from the second PCI of the second LP-SS or the second SSBs that are associated with the second beam.

Second SSBs or, in general, second RS such as second LP-SS are transmitted by the gNB over Cell-B using the second beam in order to determine whether a UE is present in the area of Cell-B. A periodicity of the second SSBs or second RS can be configured to a large value in order to reduce power consumption at the gNB and the UE that is associated with periodic transmission or reception of SSBs, respectively. Alternatively, a UE may assume a periodicity value that can be also defined in the specifications of the system operation.

FIG. 12 illustrates a flowchart of an example UE procedure 1200 for transmitting a physical random access channel (PRACH) according to embodiments of the present disclosure. For example, procedure 1200 can be performed by any of the UEs 111-116 of FIG. 1, such as the UE 111. This example is for illustration only and other embodiments can be used without departing from the scope of the present disclosure.

As illustrated in FIG. 12, in the procedure 1200, the UE is in an RRC_IDLE or RRC_INACTIVE state and receives an early indication by an SS/PBCH block. A UE is provided a configuration by a SIB associated with a first SS/PBCH block or a first LP-SS for reception of synchronization signals, such as LP-SSs, and a corresponding PRACH configuration 1210. The UE monitors the synchronization signals based on the configuration 1220. After receiving the synchronization signals, the UE transmits a PRACH based on the PRACH configuration using a spatial filter associated with the synchronization signals 1230.

The following examples refer to procedures for receiving an early indication and transmitting, in response to the early indication, an early acknowledgment for a UE in Cell-B.

In a first example, a UE in RRC_IDLE or in RRC_INACTIVE state can be provided, in a SIB, associated with a first beam on a cell, a configuration for LP-SS or for SS/PBCH block (SSB) associated with a second beam on the cell. The UE periodically receives the SSB or the LP-SS according to the configuration. The UE is also provided a configuration for PRACH resources by the SIB for transmission of an early acknowledgment signal in response to the reception of an LP-SS or of an SSB. The PRACH configuration may also include a number of N_{preamble}^{rep}>1 preamble repetitions for the PRACH transmission if the UE would transmit the PRACH with repetitions. The UE transmits a PRACH on a determined set of resources, using a spatial filter associated with the LP-SS or the SSB. After acquiring synchronization using the LP-SS or the SSB, the UE transmits an early acknowledgment signal, such as the PRACH, using a spatial filter associated with the LP-SS or the SSB. It is also possible that the configuration for the LP-SS or for the SSB is not provided in the SIB and is instead provided by the specifications of the system operation. Similar, it is possible that the PRACH configuration is not provided by the SIB and is instead determined by the specification of the system operation or is configured at the UE by the service provider or by the UE provider.

In a second example, a UE in RRC_IDLE or in RRC_INACTIVE state can be provided, in a SIB associated with a SS/PBCH block transmission on a cell, a configuration for synchronization signals (SS) transmissions on the cell. The SS/PBCH block has first quasi co-location (QCL) properties and the SS has second QCL properties, different than the first QCL properties. A SS can include PSS, or PSS and SSS, or an LP-SS. The gNB transmits the SS on the cell and the UE periodically receives the SS according to the configuration. The UE performs time/frequency synchronization based on a received SS. In response to the SS reception, the UE transmits an early acknowledgment such as a PRACH. It is also possible that the configurations of the SS and of the PRACH in response to the SS reception are predefined in the specifications of the system operation. Then, in response to the PRACH transmission after the SS/LP-SS reception, the UE can receive an SSB providing finer time/frequency synchronization, additional system information, and subsequently also receive one or more SIBs.

In a third example, a UE in RRC_IDLE or in RRC_INACTIVE state can be provided, in a SIB associated with a SS/PBCH block transmission on a cell, a configuration for low power synchronization signals (LP-SS) transmissions on a cell. The SS/PBCH block has first QCL properties and the LP-SS has second QCL properties, different than the first QCL properties. The gNB transmits the LP-SS on the cell and the UE periodically receives the LP-SS according to the configuration. The UE performs time/frequency synchronization based on the LP-SS. In response to the LP-SS reception, the UE transmits an early acknowledgment such as a PRACH. It is also possible that the configurations of the LP-SS and of the PRACH are not provided by a SIB and are instead determined in the specifications of the system operation. Then, the reception of the SS/PBCH block by the UE can be after the reception of the LP-SS and the transmission of the PRACH by the UE.

A configuration for LP-SS can be subject to a UE capability. For example, when the UE has a low-power receiver and is capable to receive the LP-SS, the UE transmits a message to the gNB and the gNB provides a configuration for the LP-SS associated with a beam. Alternatively, when a UE capability to receive LP-SS is mandatory, the UE can directly attempt to receive LP-SS, for example based on a configuration defined in the specifications of the system operation.

When a UE is capable of receiving with a low-power receiver, such as a receiver for on-off keying, and with a normal receiver, such as an OFDM-based receiver, a gNB may provide a configuration for LP-SS or for SSBs. The gNB provides configurations for LP-SS and for SSBs, wherein each configuration is associated with a cell area or a beam or a time interval. When such configuration is not provided, the UE can receive LP-SS or SSBs based on respective configurations defined in the specifications of the system operation.

A configuration for synchronization signals is associated with a cell or with a frequency carrier/BWP of the cell. For example, the configuration for LP-SS is associated with a first cell, or with a first frequency carrier/BWP of the first cell, and applies when the UE is located within or camps on the first cell, or on the first frequency carrier/BWP of the first cell, and the configuration of SSBs is associated with a second cell, or with a second frequency carrier/BWP of the first cell, and applies when the UE is located within or camps on the second cell, or on the second frequency carrier/BWP of the first cell. In each cell or frequency carrier/BWP, the UE reads a corresponding SIB, when applicable, or reads a SIB that includes the information for the multiple cells. In any cell, the gNB (e.g., the BS 102) transmits LP-SS or SSBs using a corresponding beam. The trigger for (de-)activating the LP receiver or the main receiver is a cell change. In the following, for brevity, different areas of a cell are considered and the embodiments are directly applicable to different frequency carriers/BWPs of the cell.

A configuration by a SIB for synchronization signals, such as LP-SS, is associated with a beam. For example, the gNB transmits LP-SS using a first beam (first QCL properties) and SS/PBCH using a second beam (second QCL properties), wherein the first and second beams cover a same area. The UE activates the LP receiver when the received power of the LP-SS is above a configured threshold indicated in the SIB.

A configuration for synchronization signals is associated with a time interval. In one example, a configuration for transmissions of LP-SS on a cell or on a frequency carrier/BWP of the cell applies during a first time interval and a configuration for transmissions of SSBs applies during a second time interval. For consecutive first and second time intervals, a UE activates an LP receiver (and deactivates a main receiver) at the start of the first time interval and activates the main receiver (and deactivates the LP receiver) at the start of the second time interval. A configuration for time intervals and/or an associated periodicity is provided by the gNB, for example in a SIB. In the following, for brevity, different areas of a cell are considered and the embodiments are directly applicable to different frequency carriers/BWPs of the cell.

In a fourth example, LP-SS and SSBs, of same or different periodicity are multiplexed, and the UE can activate the LP receiver based on the received power of the LP-SS being above a configured threshold. Otherwise, the UE activates the main receiver.

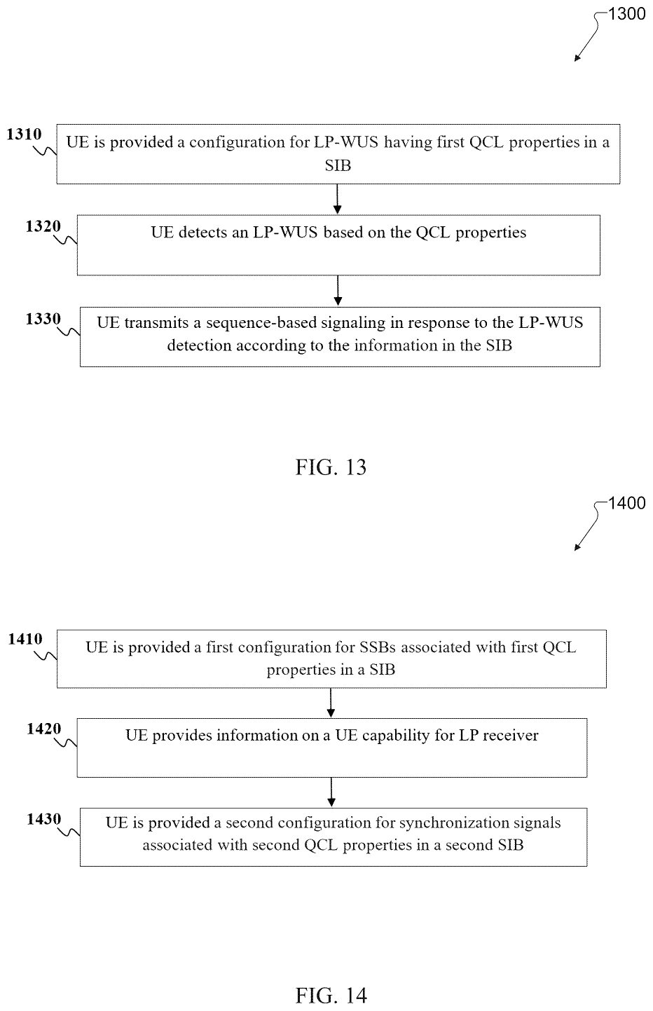

FIG. 13 illustrates a flowchart of an example UE procedure 1300 for transmitting a sequence-based signal according to embodiments of the present disclosure. For example, procedure 1300 can be performed by any of the UEs 111-116 of FIG. 1, such as the UE 112. This example is for illustration only and other embodiments can be used without departing from the scope of the present disclosure.

As illustrated in FIG. 13, in the procedure 1300, the UE receives a LP-WUS and transmits a sequence-based signaling. A UE is provided a configuration for low power wake up signal (LP-WUS) having first QCL properties in a SIB 1310. Based on information in the SIB, the UE detects an LP-WUS based on the QCL properties 1320. The UE transmits a signal, such as a sequence-based signal, in response to the LP-WUS detection according to the information in the SIB 1330 using a spatial filter determined based on the QCL properties.

In a second approach, a UE in RRC_IDLE or in RRC_INACTIVE state can be provided, in a SIB, a configuration for receptions of a first low-power wake up signal (LP-WUS), such as an LP-SS, on a cell. The SIB is associated with a SS/PBCH block. The SS/PBCH block has first QCL properties, the LP-WUS has second QCL properties, and the first QCL properties are different from the second QCL properties. Alternatively, the configuration of the LP-SS can be defined in the specifications of the system operation. The UE receives the LP-WUS according to the configuration using a LP receiver. After detection of the LP-WUS, the UE transmits an acknowledgment such as a PRACH or a second LP-WUS.

In one example, the UE receives the LP-WUS according to the configuration using a LP receiver, and after detection of the LP-WUS, the UE switches off the LP receiver and starts receptions of SSBs using the main receiver.

FIG. 14 illustrates a flowchart of an example UE procedure 1400 for receiving configurations according to embodiments of the present disclosure. For example, procedure 1400 can be performed by any of the UEs 111-116 of FIG. 1, such as the UE 113. This example is for illustration only and other embodiments can be used without departing from the scope of the present disclosure.

As illustrated in FIG. 14, in the procedure 1400, illustrates an example procedure for a UE to receive, in a first SIB, information for acquiring a second SIB that provides information for SSBs according to the disclosure. A UE is provided a first configuration for SSBs associated with first QCL properties in a SIB 1410. The UE provides information for a UE capability for LP receiver 1420. The UE is provided a second configuration for synchronization signals associated with second QCL properties in a second SIB 1430.

In one example, the UE receives the LP-WUS according to the configuration using a LP receiver, and after detection of the LP-WUS, the UE acquires a new SIB that includes the information for receptions of SSBs and receives the SSBs using the main receiver.

In a third approach, prior to transmitting synchronization signals with first QCL properties, the gNB transmits first SSBs with second QCL properties. Based on a reception of a SS/PBCH block, the UE can provide capabilities for reception of the synchronization signals, for example after establishing RRC connection. Based on UE capabilities or the UE location, the gNB configures synchronization signals associated with the first QCL properties.

In a fourth approach, a UE in RRC_IDLE or in RRC_INACTIVE state is provided, in a SIB, a first configuration for LP-SS associated with first QCL properties and a second configuration for SSBs associated with second QCL properties. The UE periodically receives LP-SS using a LP receiver according to the first configuration. A detection of the LP-SS triggers a de-activation of the LP receiver and an activation of the main receiver for the UE to start periodic receptions of the SSBs according to the second configuration and initiate a random access procedure. It is also possible that the configurations for the LP-SS reception and for the SSB reception are not provided in a SIB and are instead defined in the specifications of the system operation.

The start of receptions of the SSBs by the UE according to the second configuration after detection of the LP-SS can be subject to a minimum time interval between the time instance when the UE detects the LP-SS and the time instance when the UE monitors for an SS/PBCH block index. The minimum time interval can be predefined or can be subject to a UE capability associated to a UE power state while the LP receiver is active and detects the LP-SS. The SS/PBCH block reception can enable the UE to acquire a new SIB including information for receiving SSBs after detection of the LP-SS. The SSB reception can further be conditioned on a transmission by the UE of a signal, such as a second LP-WUS or a PRACH; otherwise, when the UE does not need to camp on the cell, the UE may not transmit the signal and may not attempt to receive the SS/PBCH block. The UE behavior can also be indicated by information in the LP-SS. For example, the LP-SS can provide at least partial information for the signal transmission by the UE, such as at least some parameters for a PRACH transmission, and can additionally provide other information such as an UL-DL TDD configuration from a predetermined set of UL-DL configurations defined in the specification of the system operation when the operating frequency band is a TDD band.

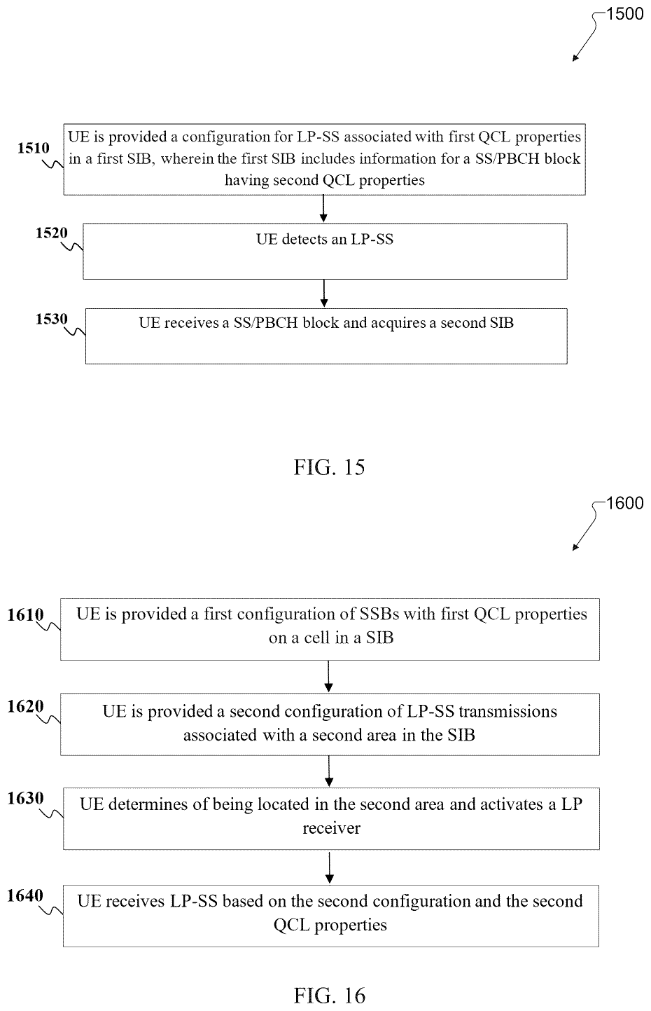

FIG. 15 illustrates a flowchart of an example UE procedure 1500 for receiving system information blocks (SIBs) according to embodiments of the present disclosure. For example, procedure 1500 can be performed by any of the UEs 111-116 of FIG. 1, such as the UE 114. This example is for illustration only and other embodiments can be used without departing from the scope of the present disclosure.

As illustrated in FIG. 15, in the procedure 1500, a UE in RRC_IDLE or RRC_INACTIVE state receives, in a first SIB, information for acquiring a second SIB that provides information for SSBs. A UE is provided a configuration for LP-SS associated with first QCL properties in a first SIB, wherein the first SIB includes information for a SS/PBCH block having second QCL properties 1510. The UE detects an LP-SS 1520. The UE receives a SS/PBCH block and acquires a second SIB 1530.

In one example, a first SIB provides a configuration for LP-SS associated with first QCL properties and a second SIB provides a configuration for SSBs associated with second QCL properties. For example, the LP-SS covers a first area that is included in the second area covered by the SSBs.

In one example, a first SIB provides a configuration for LP-SS associated with first QCL properties and a second SIB provides a configuration for SSBs associated with second QCL properties. For example, the LP-SS covers a first area that does not overlap with the second area covered by the SSBs.

In one example, a first SIB provides a configuration for LP-SS associated with first QCL properties, and additionally provides second parameters, such as second QCL properties or time-frequency resources, associated with the transmission of a second SIB and SSBs, wherein the second SIB provides a configuration for receptions of the SSBs.

In one example, a first SIB provides a configuration for LP-SS associated with first QCL properties, and additionally provides a sub-carrier spacing and a periodicity of the time intervals, for example half-frames, where SSBs are transmitted by the gNB/received by a UE.

In one example, a SIB provides a configuration for LP-SS associated with first QCL properties and a configuration for receptions of SSBs. For example, the LP-SS covers a first area and outside of the first area, the UE needs to acquire a new SIB.

In one example, a configuration for a reception of a first LP-SS is predefined in the specifications of the system operation. The first LP-SS can provide information for a transmission of a PRACH or of a second LP-SS, or such information can be predefined in the specifications of the system operation. The LP-SS can provide information for reception of SS/PBCH blocks or such information can be predefined in the specifications of the system operation. The LP-SS can provide information for an UL-DL TDD configuration or time intervals for reception of SS/PBCH blocks or for transmission of PRACH or of a second LP-SS can be predefined relative to the time interval for the reception of the first LP-SS, or can be additionally or alternatively indicated by the first LP-SS.

The following descriptions and embodiments for a UE performing measurements and corresponding measurement reporting equally apply when measurements and reporting by the UE are based on SS/PBCH block receptions or CSI-RS receptions.

A satellite or a serving gNB may provide coverage in a portion of a cell for a certain time period. For the satellite or the serving gNB to adapt coverage over the cell, hence adapting network (e.g., the network 130) operations in different areas or in different frequency carriers/BWPs of the cell, the satellite or the serving gNB determines whether there is a need to provide coverage in areas or in carriers/BWPs of the cell that are currently out-of-coverage. For example, the satellite or serving gNB provides coverage in a first area or a first carrier/BWP of the cell by using one or multiple beams, wherein the first area or the first carrier/BWP does not include a second area or a second carrier/BWP, and determines whether to provide coverage in the second area or in the second carrier/BWP of the cell by transmitting an indication, such as a first LP-SS or an SSB, in the second area or in the second carrier/BWP and subsequently monitoring for a reception of a response, such a second LP-SS or a PRACH, to the indication. A UE in the second area or in the second carrier/BWP of the cell may start monitoring for the indication and may transmit a response to the indication, wherein the response may depend on at least a UE capability associated with the reception of the indication if such capability is not a mandatory one. Prior to monitoring for the indication, the UE needs to acquire time and frequency synchronization with a cell and receive information for receiving the indication on the same cell as, or on a different cell from, the cell where the UE has acquired synchronization. In the following, for brevity, different areas of a cell are considered and the embodiments are directly applicable to different frequency carriers/BWPs of the cell.

In one example, the UE can acquire synchronization on a first cell that covers a first area, be provided a configuration for receiving the indication on a second cell that covers a second area, and monitor for the reception of the indication in the second cell according to the configuration. The first area of the first cell can include the second area of the second cell, or the first area and the second area do not overlap.

In one example, the UE can acquire synchronization on a first cell that covers a first area with a first beam, be provided a configuration for receiving the indication on a second beam that covers a second area, and monitor for the reception of the indication according to the configuration. The first area can include the second area, or the first area and the second area do not overlap.

The indication by the satellite or the serving gNB can be provided by a set of synchronization signals, or a set of SSBs, or a low power signal, such as a low power synchronization signal (LP-SS) that the UE may be able to receive depending on a UE capability and on the UE location. The UE may also receive a configuration for a transmission of a response to the indication, wherein the configuration can include information for resources for a transmission of an uplink signal or channel, such as a wake-up signal (WUS) or a low power wake-up signal (LP-WUS).

After reception of the indication, the UE may transmit, in response to the indication, the uplink signal or channel, or the WUS, to indicate to the satellite or the serving gNB a UE presence and/or a UE request to be provided coverage.

After transmission of the response by the UE, when the response indicates a UE presence, the UE may transition to a lower power state or transition to discontinuous reception (DRX), and periodically wake up to monitor for the reception of the indication according to a configured periodicity.

After transmission of the response by the UE, when the response indicates a UE request to be provided coverage, the UE starts monitoring, for example after a configured or indicated time period from the transmission of the response, for receiving SSBs associated with a beam according to a configuration.

Therefore, embodiments of the present disclosure further recognize that there is a need for the UE to acquire information for receiving SSBs or LP-SSs associated with a location and attempt to receive the SSBs or LP-SSs.

Embodiments of the present disclosure further recognize that there is another need for the UE to receive information for a configuration of an UL WUS transmission associated with receptions of SSBs or LP-SSs and the location.

Embodiments of the present disclosure further recognize that there is another need to define the signalling associated with receptions and transmissions of synchronization signals.

This disclosure relates to receiving second synchronization signals in an area of a cell. This disclosure also relates to configuring and indicating information associated with the second synchronization signals. This disclosure also relates to low power synchronization signals and UL wake-up signal in response to the reception of second synchronization signals in the area of the cell.

Set of In one approach, a gNB transmits first SSBs over a first area of a cell using a first beam and transmits second synchronization signals (SS) over a second area of the cell using a second beam. For example, the gNB transmits the first SSBs using a wide first beam that is active for a time interval over the first cell. In a time gap between two subsequent time intervals with the first beam being active, the gNB disactivates the first beam for network (e.g., the network 130) energy saving purposes. A UE located in the first cell, during time intervals with the first beam being active, can receive the first SSBs, perform time and frequency synchronization based on the received first SSBs and receive a SIB associated with an SSB transmission on the first cell.

FIG. 16 illustrates a flowchart of an example UE procedure 1600 for receiving low power synchronization signal (LP-SS) according to embodiments of the present disclosure. For example, procedure 1600 can be performed by any of the UEs 111-116 of FIG. 1, such as the UE 115. This example is for illustration only and other embodiments can be used without departing from the scope of the present disclosure.

As illustrated in FIG. 16, in procedure 1600, the UE receives a LP-SS in an area of a cell based on a configuration provided in a SIB associated with the cell. A UE is provided a first configuration of SSBs with first QCL properties on a cell in a SIB 1610. The UE is provided a second configuration of LP-SS transmissions associated with a second area in the SIB, wherein the LP-SS transmissions are with second QCL properties 1620. The UE determines of being located in the second area and activates a LP receiver 1630. The UE receives LP-SS based on the second configuration and the second QCL properties 1640.

In one example, the SIB may provide a first configuration for time location and periodicity of first SSBs on the first cell or first area and also provides a second configuration for time location and periodicity for low power synchronization signals (LP-SS) transmissions associated with a second area on the first cell. The first configuration is associated with the first beam and the SSB has first QCL properties.

The second configuration is associated with the second beam and the LP-SS has second QCL properties, different than the first QCL properties.

In one example, the first beam is a wide beam and the second beam is a narrow beam.

In one example, the first area associated with the first beam is larger than the second area associated with the second beam, and the second area is included in the first area.

In one example, the first area associated with the first beam is larger than the second area associated with the second beam, and the second area does not overlap partially or entirely with the first area.

In one example, multiple configurations of LP-SS transmissions are associated with corresponding multiple periodicities or multiple patterns and corresponding multiple areas. The multiple configurations of LP-SS transmissions can be associated with corresponding multiple beams, and the LP-SS transmissions have corresponding different QCL properties.

In one example, the first configuration of first SSBs is associated with the first cell and the second configuration of LP-SS is associated with a second cell.

In one example, the first configuration of first SSBs is associated with the first cell and the second configuration of LP-SS is associated with an area of the first cell.

In one example, a SIB associated with the first cell provides information of the second configuration of LP-SS and of the second area associated with LP-SS transmissions.

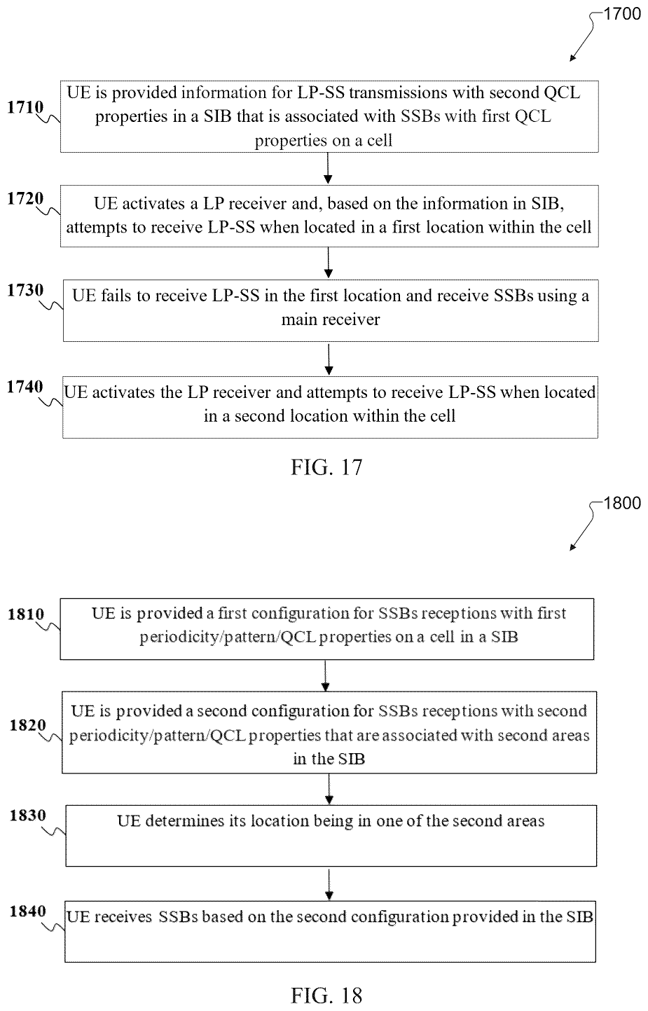

FIG. 17 illustrates a flowchart of an example UE procedure 1700 for attempting to receive LP-SS according to embodiments of the present disclosure. For example, procedure 1700 can be performed by any of the UEs 111-116 of FIG. 1, such as the UE 116. This example is for illustration only and other embodiments can be used without departing from the scope of the present disclosure.

As illustrated in FIG. 17, in procedure 1700, the UE receives a LP-SS in a cell based on a configuration provided in a SIB associated with the cell. A UE is provided information for LP-SS transmissions with second QCL properties in a SIB that is associated with SSBs with first QCL properties on a cell 1710. The UE activates a LP receiver and, based on the information in SIB, attempts to receive LP-SS when located in a first location within the cell 1720. The UE fails to receive LP-SS in the first location and receives SSBs using a main receiver 1730. The UE activates the LP receiver and attempts to receive LP-SS when located in a second location within the cell 1740.

FIG. 18 illustrates a flowchart of an example UE procedure 1800 for receiving synchronization signal blocks (SSBs) according to embodiments of the present disclosure. For example, procedure 1800 can be performed by the UE 116 of FIG. 3. This example is for illustration only and other embodiments can be used without departing from the scope of the present disclosure.

As illustrated in FIG. 18, in the procedure 1800, the UE receives a LP-SS in an area of a cell based on a configuration provided in a SIB associated with the cell. A UE is provided a first configuration for SSBs receptions with first periodicity/pattern/QCL properties on a cell in a SIB 1810. The UE is provided a second configuration for SSBs receptions with second periodicity/pattern/QCL properties that are associated with second areas of the cell in the SIB 1820. The UE determines its location being in one of the second areas 1830. The UE receives SSBs based on the second configuration provided in the SIB 1840.

When a UE is capable of receiving with a low-power receiver, such as a receiver for on-off keying, and with a normal receiver, such as an OFDM-based receiver, and the gNB provides a first configuration for normal SS (SSBs) in a first area and a second configuration for LP-SS associated with a second area, the UE activates a LP receiver and receives the LP-SS when it is located in the second area. The first configuration of SSBs transmissions can be associated with a first periodicity and the second configuration of LP-SS transmissions can be associated with a second periodicity.

For example, the UE receives a SIB associated with an SSB transmission on the first cell, and acquires system information (SI) that provides the second configuration for LP-SS transmissions with the second periodicity and also provides an association of the LP-SS transmissions with a location, referred as a second area. The SI provides multiple configurations for LP-SS transmissions with corresponding periodicities and also provides an association of the multiple configurations for LP-SS transmissions with corresponding multiple second areas. In one example, periodicities of the LP-SS transmissions associated with different second areas are different. In one example, periodicities of the LP-SS transmissions associated with different second areas are the same.

In one example, the multiple areas do not overlap. In one example, the multiple areas are within the first area of the first cell.

When the UE is able to determine its location and identifies when being located in the second area associated with LP-SS transmissions, the UE activates a LP receiver and receives the LP-SS with the LP receiver.

When the UE is not able to determine its location, in a first location within the first cell the UE can activate the LP receiver and attempt to receive the LP-SS. If reception of the LP-SS in the first location is not successful, the UE uses the main receiver to receive first SSBs. When the UE moves to a second location within the first cell, the UE may attempt again to receive the LP-SS with the LP receiver.

In one example, a SIB may provide a first configuration for time location and periodicity of first SSBs transmissions associated with a first area and a second configuration for time location and periodicity of second SSBs transmissions associated with a second area, wherein the SIB is associated with a first cell and the first cell is associated with first SSBs and first area. The first configuration is associated with a first beam and first SSBs have first QCL properties. The second configuration is associated with a second beam and second SSBs have second QCL properties, different than the first QCL properties. For example, the SIB can indicate different periodicities and/or patterns for first SSBs and second SSBs, and also indicate an association of SSBs with location. The UE can determine its location and based on the information in the SIB, can determine the periodicity and the pattern of the second SSBs transmitted in the area where the UE is located. For example, first SSBs transmitted with a wide beam and associated with a first cell are transmitted with a larger periodicity, and second SSBs transmitted with narrow beams and associated with corresponding smaller areas within the first cell are transmitted with a smaller periodicity.

When a gNB transmits first SSBs over a first cell using a first wide beam that is active continuously or intermittently, and transmits LP-SS or second SSBs with a second periodicity different from a first periodicity of the first SSBs (and/or with a second pattern different from a first pattern used for the first SSBs), using a narrow second beam, the UE can be provided in a SIB associated with the first cell and first SSBs, system information (SI) including periodicity and/or pattern for the LP-SS transmissions or the second SSBs transmissions, an association between the LP-SS transmissions or the second SSBs transmissions and a location, and additionally a configuration of a WUS or a LP-WUS transmission associated with the LP-SS transmissions or the second SSBs transmissions and the location.

A UE can transmit a WUS (or LP-WUS) to indicate to a gNB its presence in an area where the UE receives SSBs or LP-SS. A SI signalling provides a configuration of the UL WUS (or UL LP-WUS) transmission corresponding to the LP-SS transmissions or the second SSBs transmissions associated with a location.

In one example the SI provides a configuration of a WUS transmission corresponding to the LP-SS associated with the location, wherein the WUS transmission is from the UE. The UE in the location associated with the LP-SS can activate a LP receiver and monitor the LP-SS, and based on the WUS configuration can transmit the WUS after reception of the LP-SS. The WUS configuration can provide WUS transmission occasions with a periodicity, and the UE may transmit the WUS periodically after reception of the LP-SS. A time interval between the reception of the LP-SS and the transmission of the WUS in a configured WUS transmission occasion can be subject to a minimum time interval configured by the gNB and/or depending on a UE capability.

In one example the SI provides a configuration of a WUS transmission corresponding to the second SSBs associated with the location, wherein the WUS transmission is from the UE.

In one example the SI provides a configuration of a LP-WUS transmission corresponding to the LP-SS associated with the location, wherein the LP-WUS transmission is from the UE.

In one example the SI provides a configuration of a LP-WUS transmission corresponding to the second SSBs associated with the location, wherein the LP-WUS transmission is from the UE.

A UE can receive a WUS or LP-WUS in an area where the UE receives SSBs or LP-SS, wherein the WUS indicates to start a random access procedure. A SI signalling provides a configuration for receiving a DL WUS or DL LP-WUS corresponding to the LP-SS transmissions or the second SSBs transmissions associated with a location.

In one example the SI provides a configuration of a WUS transmission corresponding to the second SSBs associated with the location, wherein the WUS transmission is from the gNB. The UE in the location associated with the second SSBs receives the second SSBs, and based on the WUS configuration can monitor for WUS receptions periodically. Upon reception of the WUS, the UE may start receiving SSBs and transmitting PRACH(s) to initiate a random access procedure.

In one example the SI provides a configuration of a LP-WUS transmission corresponding to the LP-SS associated with the location, wherein the LP-WUS transmission is from the gNB. The UE in the location associated with the LP-SS can activate a LP receiver and monitor the LP-SS, and based on the LP-WUS configuration can monitor for LP-WUS receptions periodically based on the LP-WUS configuration using the LP receiver. Upon reception of the LP-WUS, the UE may activate a main receiver and start receiving SSBs and transmitting PRACH(s) to initiate a random access procedure.

Signalling to convey information related to second SS, an association of second SS and location, and an UL WUS in response to a LP-SS reception.

A SI may include information for second SS, for example LP-SS and/or second SSBs, and an association of second SS and a location. Additionally, the SI can provide a configuration of an UL WUS (or an UL LP-WUS) transmission by the UE that indicates UE presence and acknowledges reception of the second SS. Further, the SI can provide a configuration of a DL WUS (or a DL LP-WUS) transmission by the gNB that would indicate to the UE in IRRC_IDLE or RRC_INACTIVE state to start a random access procedure using first SSBs or second SS. The SI can be provided by a SIB, or by a MIB and a SIB, or by a LP-WUS.

In one example, the SI can be provided in a SIB that is associated with a first cell with first SSBs transmissions. The UE located in the first cell receives first SSBs and acquires the SIB that includes information related to the second SS. The SI information in the SIB can be any or a combination of: configuration of second SS, configuration of an association of second SS and location, and configuration of resources for an UL WUS (or a DL WUS).

In one example, the SI can be partially provided in a MIB and partially in a SIB that are associated with a first cell. For example, the MIB can include a 1-bit indication to indicate whether a configuration for second SS is provided in a SIB, e.g. in SIB1, or in SIB19, or in any other existing SIB in NR, or in a new dedicated SIB that provides parameters for second SS and for an association of the second SS and a location. The additional configuration for the LP-WUS can also be included in an existing or new SIB, and the SIB that includes the LP-WUS configuration can be the same as the SIB that includes the second SS information or the SIB that includes the second SS information and the association of the second SS and a location, or can be a different SIB.

In one example, a LP-WUS can indicate to the UE the resources for the transmission of an UL WUS that indicates the presence of the UE in the location where second SS is received. A field in the LP-WUS of 8 or more bits, or a number of bits between 8 and 16 bits, can be used to indicate the resources for the UL WUS transmission.

The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A method performed by a user equipment (UE) in a wireless communication system, the method comprising:
receiving, on a first cell, a synchronization signal associated with first quasi-collocation properties on the first cell;
transmitting, on the first cell, a physical random access channel (PRACH) in response to the reception of the synchronization signal; and
receiving, on the first cell, a synchronization signal and physical broadcast channel (SS/PBCH) block associated with second quasi-collocation properties in response to the transmission of the PRACH.

2. The method of claim 1, further comprising:
receiving, on a second cell, information indicating parameters for the reception of the synchronization signal.

3. The method of claim 1, wherein the synchronization signal provides information indicating a configuration, from a set of predetermined configurations, of parameters for the transmission of the PRACH.

4. The method of claim 1, wherein the synchronization signal provides information indicating a time-division duplexing (TDD) configuration from a set of predetermined TDD configurations.

5. The method of claim 1, wherein:
receiving the synchronization signal further comprises receiving the synchronization signal using a first spatial filter;
the method further comprises determining a second spatial filter based on the first spatial filter; and
transmitting the PRACH further comprises transmitting the PRACH using the second spatial filter.

6. The method of claim 1, wherein:
receiving the synchronization signal further comprises receiving the synchronization signal using a first spatial filter;
the method further comprises determining a second spatial filter based on the first spatial filter; and
receiving the SS/PBCH block further comprises receiving the SS/PBCH block using the second spatial filter.

7. The method of claim 1, wherein:
receiving the synchronization signal further comprises receiving the synchronization signal based on on-off keying (OOK) modulation, and
receiving the SS/PBCH block further comprises receiving the SS/PBCH block based on quadrature phase shift keying (QPSK) modulation.

8. A user equipment (UE) comprising:
a transceiver configured to:
receive, on a first cell, a synchronization signal associated with first quasi-collocation properties on a first cell;
transmit, on the first cell, a physical random access channel (PRACH) in response to the reception of the synchronization signal; and
receive, on the first cell, a synchronization signal and physical broadcast channel (SS/PBCH) block associated with second quasi-collocation properties in response to the transmission of the PRACH.

9. The UE of claim 8, wherein the transceiver is further configured to receive, on a second cell, information indicating parameters for the reception of the synchronization signal.

10. The UE of claim 8, wherein the synchronization signal provides information indicating a configuration, from a set of predetermined configurations, of parameters for the transmission of the PRACH.

11. The UE of claim 8, wherein the synchronization signal provides information indicating a time-division duplexing (TDD) configuration from a set of predetermined TDD configurations.

12. The UE of claim 8, further comprising:
a processor operably coupled to the transceiver, the processor configured to determine a second spatial filter based on a first spatial filter,
wherein the transceiver is further configured to:
receive the synchronization signal using the first spatial filter; and
transmit the PRACH using the second spatial filter.

13. The UE of claim 8, further comprising:
a processor operably coupled to the transceiver, the processor configured to determine a second spatial filter based on a first spatial filter,
wherein the transceiver is further configured to:
receive the synchronization signal using the first spatial filter; and
receive the SS/PBCH block using the second spatial filter.

14. The UE of claim 8, wherein the transceiver is further configured to receive:
the synchronization signal based on on-off keying (OOK) modulation, and
the SS/PBCH block based on quadrature phase shift keying (QPSK) modulation.

15. A base station comprising:
a transceiver configured to:
transmit, on a first cell, a synchronization signal associated with first quasi-collocation properties on a first cell;
receive, on the first cell, a physical random access channel (PRACH) associated with the synchronization signal; and
transmit, on the first cell, a synchronization signal and physical broadcast channel (SS/PBCH) block associated with second quasi-collocation properties in response to the reception of the PRACH.

16. The base station of claim 15, wherein the transceiver is further configured to transmit, on a second cell, information indicating parameters for the transmission of the synchronization signal.

17. The base station of claim 15, wherein the synchronization signal provides information indicating a configuration, from a set of predetermined configurations, of parameters for transmission of the PRACH.

18. The base station of claim 15, further comprising:
a processor operably coupled to the transceiver, the processor configured to determine a second spatial filter based on a first spatial filter,
wherein the transceiver is further configured to:
transmit the synchronization signal using the first spatial filter; and
receive the PRACH using the second spatial filter.

19. The base station of claim 15, further comprising:
a processor, operably coupled to the transceiver, the processor configured to determine a second spatial filter based on a first spatial filter,
wherein the transceiver is further configured to transmit:
the synchronization signal using the first spatial filter; and
the SS/PBCH block using the second spatial filter.

20. The base station of claim 15, wherein the transceiver is further configured to transmit:
the synchronization signal based on on-off keying (OOK) modulation, and
the SS/PBCH block based on quadrature phase shift keying (QPSK) modulation.
